(19) United States
(12) Patent Application Publication
(10) Pub. No.: US 2024/0386064 A1
(43) Pub. Date: Nov. 21, 2024

(54) SYSTEM AND METHOD FOR IDENTIFYING LONG-TAIL TOPICS AND CONTENT AND APPLICATIONS THEREOF

(71) Applicant: YAHOO ASSETS LLC, New York, NY (US)

(72) Inventors: Sanika Shirwadkar, Milpitas, CA (US); Kostas Tsioutsiouliklis, Saratoga, CA (US); Nils Schimmelmann, Mountain View, CA (US)

(21) Appl. No.: 18/320,350

(22) Filed: May 19, 2023

(51) Int. Cl. G06F 16/9535

(52) U.S. Cl. CPC G06F 16/9535

(57) ABSTRACT

The present teaching relates to method, system, medium, and implementations for content serving. A user's profile characterizing the user's long-tail interest with respect to some long-tail topics may be obtained. Each long-tail topic in the user's profile is associated with a long-tail topic score representing a degree of the user's interest in the long-tail topic. Long-tail content in some long-tail topics may be identified for the user and sent to the user. When information about online activities of the user directed to the long-tail content is received, corresponding long-tail topic scores in the user profile associated with the long-tail topics are updated based on the user's online activities.

### BACKGROUND

### 1. Technical Field

The present teaching generally relates to computers. More specifically, the present teaching relates to data analytics and application thereof.

### 2. Technical Background

With the advancement of the Internet, most people in the society now conduct their daily affairs online, including consuming different types of content (articles or videos), checking out different products, making purchases of just about everything, enjoying entertainment, receiving/providing education, or even taking virtual vacations. Such a shift in social behavior has motivated most entities, including individuals, companies, organizations, universities, or interest groups, to place a tremendous amount of information on the Internet to share, to motivate discussions, and to monetize. This is illustrated in FIG. 1A, where various content sources 130 expose their content to users 110 users 110 via network 120. Users consume content on their devices via Internet connections through network 120, either directly different content sources 130 (including publishers' website, social interest websites, social media platforms, . . . , eCommerce website, and manufacturers' websites) or through a content engine 140. To assist users to access information of their interests in such a sea of information, the content engine 140 (search engines or content portals) places much effort to provide information of interests for each individual online users via personalization.

To personalize, information about each user may be collected to build users' personal profiles 150, as shown in FIG. 1A. Different types of information, as illustrated in FIG. 1B, may be utilized to reflect users' preferences, including demographics or interests of each user, which may either be declared (by the user), assigned (suggested by others), or estimated (from what users do). Traditionally, user interests may be estimated based on any online/offline information related to the user, such as user's search or content consumption history, user's online activities with respect to content of different topics, user's participation of various social groups, or even what others in the community relating to a user like or do (e.g., trendy topics and friends' activities). A user profile may be constructed to reflect what the user may like based on user's own activities, such as engagement with certain content or communications with others, in order to have some confidence in the estimated interests. This is shown in FIG. 1C. A user's interests may also be inferred from friends' activities or trendy topics in the population. Different means to estimate a user's interests may yield overlap, as shown in FIG. 1C and such overlaps reinforce the estimated interests.

However, as each individual may have some unusual or unique interests (or long-tail interests) that may not overlap with others but nevertheless quite important to the individual. Current state of art focuses on estimating popular interests shared by many so that content can be provided (either via search or recommendation) to a mass volume of users. As such, there is currently no effective means to characterize long-tail interests via user profiles, let alone to provide information to a user in accordance with the user's long-tail interests.

Thus, there is a need for a solution that addresses the issues discussed above.

### SUMMARY

The teachings disclosed herein relate to methods, systems, and programming for information management. More particularly, the present teaching relates to methods, systems, and programming related to hash table and storage management using the same.

In one example, a method, implemented on a machine having at least one processor, storage, and a communication platform capable of connecting to a network for content serving. A user's profile characterizing the user's long-tail interest with respect to some long-tail topics may be obtained. Each long-tail topic in the user's profile is associated with a long-tail topic score representing a degree of the user's interest in the long-tail topic. Long-tail content in some long-tail topics may be identified for the user and sent to the user. When information about online activities of the user directed to the long-tail content is received, corresponding long-tail topic scores in the user profile associated with the long-tail topics are updated based on the user's online activities.

In a different example, a system is disclosed for content serving, which includes a content search/recommendation engine, a long-tail interest content retriever, a user interface, and a long-tail interest tracker. The content search/recommendation engine is configured for obtaining a user's profile with characterization of the user's long-tail interest with respect to some long-tail topics. Each long-tail topic in the user's profile has a long-tail topic score representing a degree of the user's interest in the long-tail topic. The long-tail interest content retriever is configured for identifying long-tail content for the user in some long-tail topics, which is then sent to the user via the user interface. The long-tail interest tracker is configured for receiving information about user's online activities directed to the long-tail content and then updating accordingly the long-tail topic scores in the user profile associated with the some long-tail topics.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for content serving. The information, when read by the machine, causes the machine to perform various steps. A user's profile characterizing the user's long-tail interest with respect to some long-tail topics may be obtained. Each long-tail topic in the user's profile is associated with a long-tail topic score representing a degree of the user's interest in the long-tail topic. Long-tail content in some long-tail topics may be identified for the user and sent to the user. When information about online activities of the user directed to the long-tail content is received, corresponding long-tail topic scores in the user profile associated with the long-tail topics are updated based on the user's online activities.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A depicts an exemplary traditional framework for users to access online content;

FIG. 1B illustrates exemplary types of information traditionally included in a user profile used for personalization;

FIG. 1C illustrates exemplary aspects of considerations traditionally used for estimating a user's interests;

FIG. 2 depicts an exemplary improved framework to provide enriched content to users based on enriched user profiles with estimated long-tail interests, in accordance with an embodiment of the present teaching;

FIG. 3A depicts an exemplary high-level system diagram of an enriched content engine, in accordance with an embodiment of the present teaching;

FIG. 3B illustrates an exemplary representation of a user's interests including both popular and long-tail interests, in accordance with an embodiment of the present teaching;

FIG. 3C is a flowchart of an exemplary process of an enriched content engine, in accordance with an embodiment of the present teaching;

FIG. 4A depicts an exemplary high level system diagram of a long-tail (LT) topic/content determiner, in accordance with an embodiment of the present teaching;

FIG. 4B is a flowchart of an exemplary process of a LT topic/content determiner, in accordance with an embodiment of the present teaching;

FIG. 5A shows exemplary considerations in determining a long-tail interested topic, in accordance with an embodiment of the present teaching;

FIG. 5B depicts an exemplary high-level system diagram of a long-tail interest tracker, in accordance with an embodiment of the present teaching;

FIG. 5C is a flowchart of an exemplary process of a long-tail interest tracker, in accordance with an embodiment of the present teaching;

FIG. 6 is an illustrative diagram of an exemplary mobile device architecture that may be used to realize a specialized system implementing the present teaching in accordance with various embodiments; and

FIG. 7 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

The present teaching discloses an exemplary framework for enhanced user profiling and personalization by identifying long-tail topics and user's interests in such long-tail topics. Long-tail content may also be recognized so that content in interested long-tail topics may be curated and used in personalizing content related services. The method and system as disclosed herein with respect to the present teaching improves the state of the art in the sense that it recognizes long-tail topics to ensure that user profiles may be established by including both users' usual popular and long-tail interests. In addition, the present teaching may also recognize long-tail content via topics included therein so that long-tail content may be recommended to users interested in long-tail content of certain topics. In some embodiments, with detected long-tail interests of users as well as long-tail content, the present teaching may also be provided to ensure that long-tail content in long-tail topics is adequately curated so that a content pool so created may provide enriched contents to serve users according to both their popular as well as long-tail interests.

The present teaching discloses exemplary means to determining long-tail topics based on topic uniqueness scores determined with respect to different topics. With respect to an article, it may be determined whether the article is deemed as long-tail content based on an article uniqueness score, which may be determined by aggregating the topic uniqueness scores of the relevant topics associated with the article. According to the present teaching, to track a user's interest in any long-tail topic, an interest score associated with the long-tail topic may be accumulated over time so that based on user's level of engagement with long-tail content involving the long-tail topic. In this manner, enriched user profiles may be dynamically updated by tracking users' online activities with respect to different content, including long-tail content with different topics. With the accumulate interest score on each long-tail topic, the user's interest in a long-tail topic is adapted dynamically over time. Such adapted user profiles in their interest in long-tail topics enable improved content related services and, hence, user experiences.

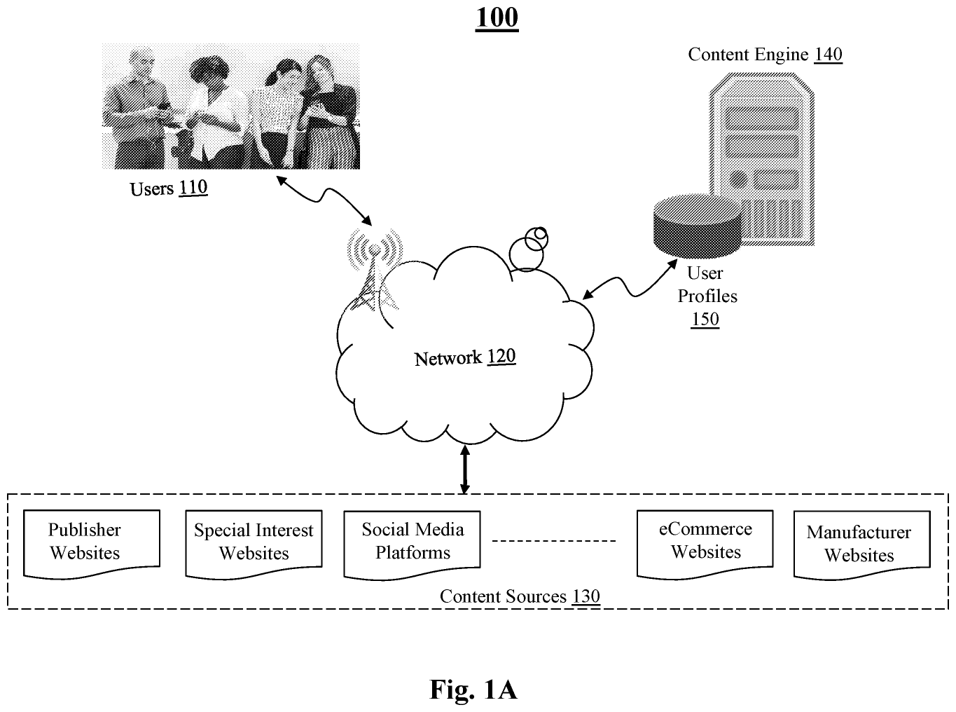

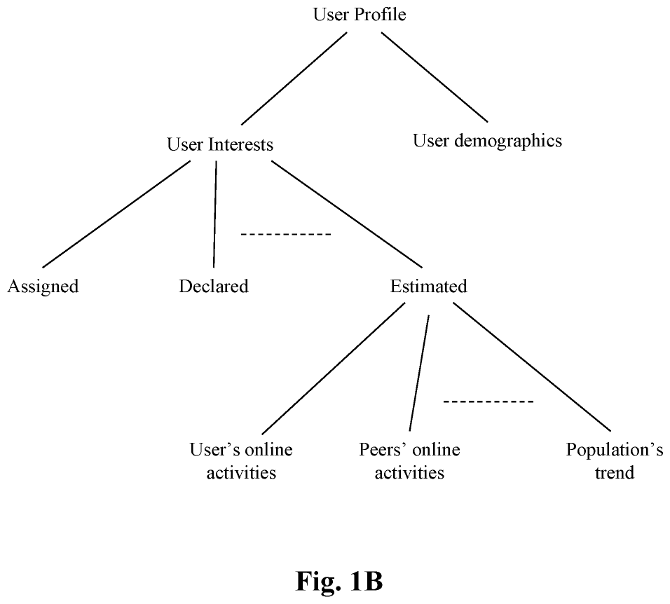

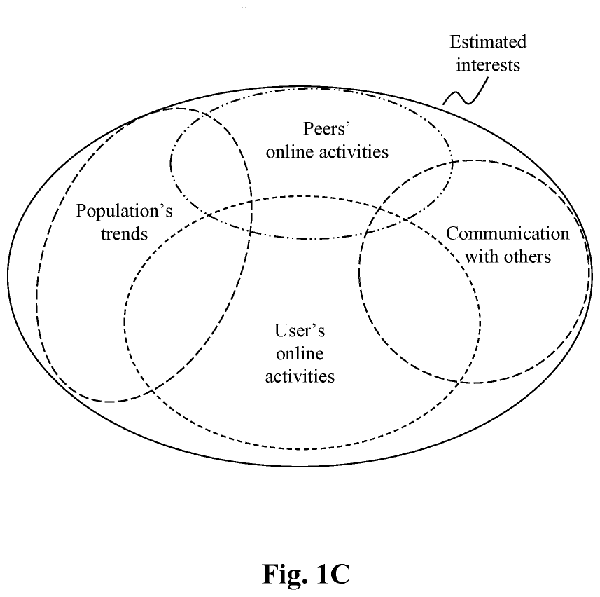

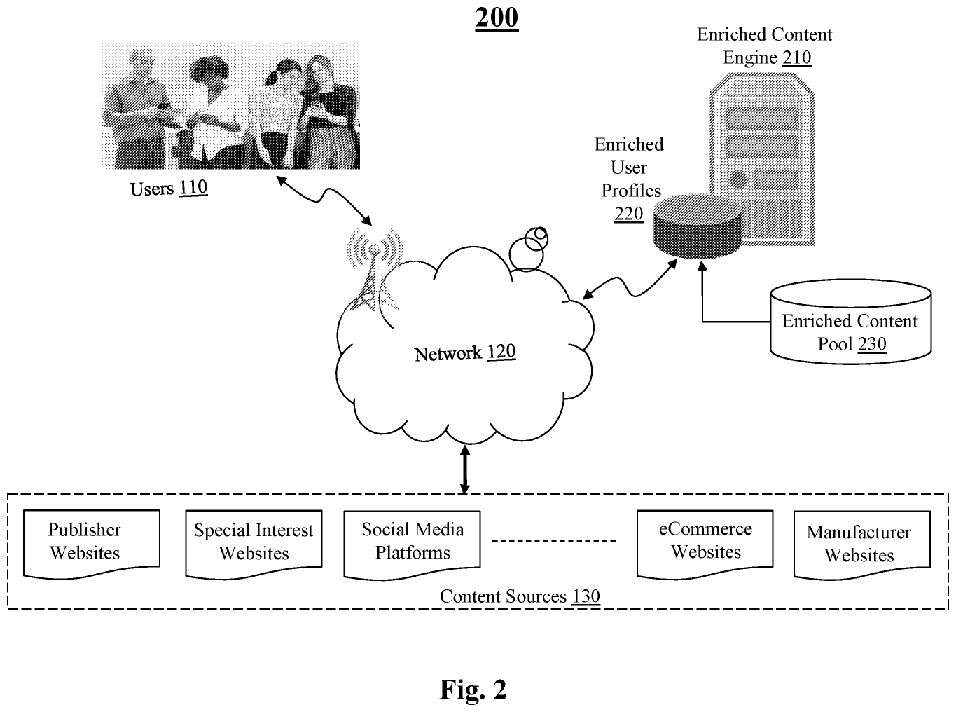

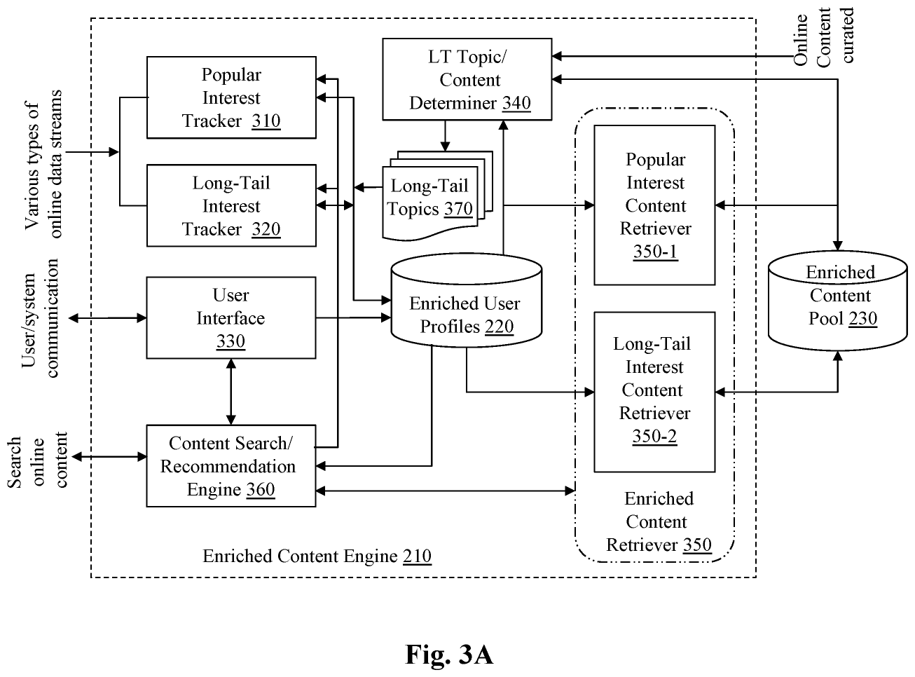

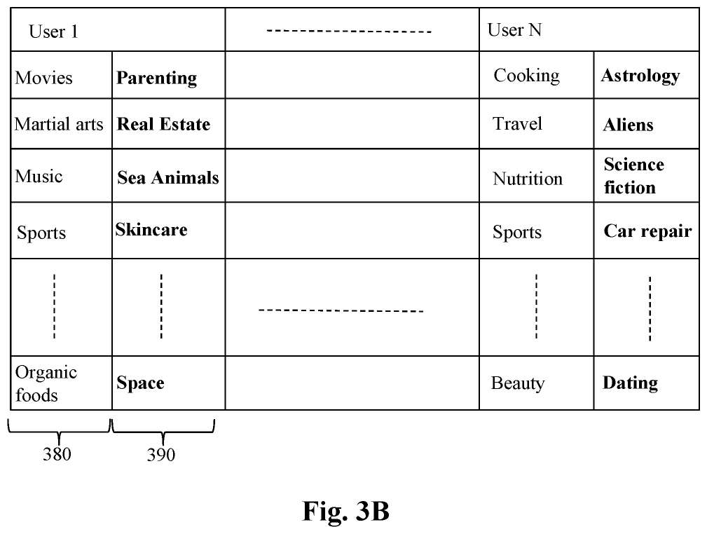

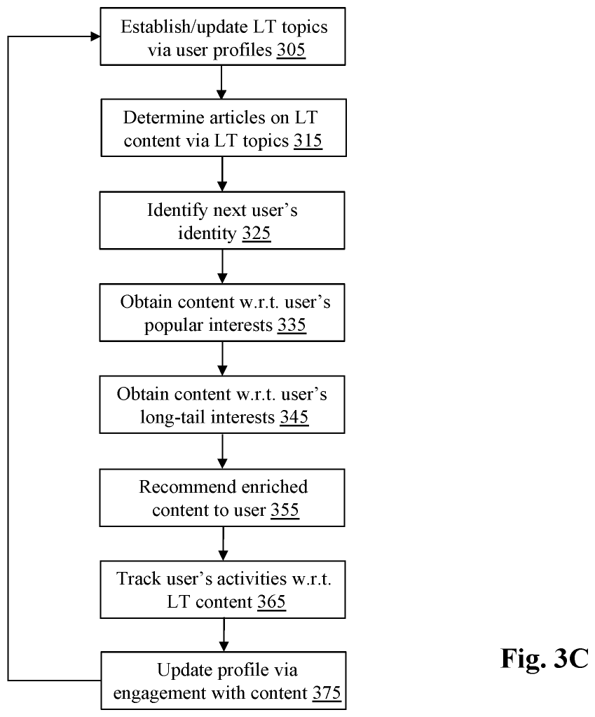

FIG. 2 depicts an exemplary improved framework 200 with an enriched content engine 210 that provides enhanced content related services based on content in 230 to users 110 by personalization via enriched user profiles 220 with estimated long-tail interests, in accordance with an embodiment of the present teaching. While the network configuration presents the same connections, as will be seen below, as the enriched content services may be based on enriched user profiles with estimated long-tail interests, it provides a more complete personalization scheme and, this, improved services to users 110 as compared with the framework 100 shown in FIG. 1A. Details on how to enrich the personalization and accordingly content related services are provided below with reference to FIGS. 3A-5C.

FIG. 3A depicts an exemplary high-level system diagram of the enriched content engine 210, in accordance with an embodiment of the present teaching. According to the present teaching, to provide enriched content services to accommodate long-tail interests of different users, it may be needed to identify long-tail topics, long-tail content, and ensure that the enriched content pool 230 include adequate content to serve various dynamically changing long-tail interests of different users 110. To achieve these aspects to enhance services, the enriched content engine 210 comprises a popular interest tracker 310, a long-tail interest tracker 320, a user interface 330, a long-tail (LT) content determiner 340, an enriched content retriever 350, and a content search/recommendation engine 360.

The popular and long-tail interest trackers 310 and 320 may be provided for continually monitor user interactions with content of various topics (popular and long-tail) and dynamically adapt the users' enriched profiles in 220 so that the enriched profiles not only reflect the users' popular and long-tail interests but also are able to adapt when the users' interests change over time. The user interface 330 may be provided for interfacing with users for, e.g., signing up a service, communicating with users to solicit information on demographics and/or declared interests, receiving search queries from users, and sending content (either recommended or searched based a query) to users. The content search/recommendation engine 360 may be provided for gathering content to be provided to users. In some embodiments, the enriched content engine 210 may recommend to user content from the enriched content pool 230 according to users' interests represented in their respective enriched profiles. The enriched content engine 210 may also operate as a search engine to search content, either from the enriched content pool 230 or from different online content sources 130, based on queries from users and optionally rank the searched online content based on interests of individual users as described in corresponding enriched profiles.

The enriched content retriever 350 may be provided for retrieving or searching content with respect to a user from the enriched content pool 230 based on different interests of the user specified in the user's enriched profile in 220. In some embodiments, the enriched content retriever 350 may be triggered by, e.g., a request from the content search/recommendation engine 360 with information indicating, e.g., specific interested topics of the user. In this illustrated embodiment, the enriched content retriever 350 includes two separate retrievers for popular content and for long-tail content. One may correspond to a popular interest content retriever 350-1 for retrieving content from the pool that are directed to popular topics. The other may correspond to a long-tail interest content retriever 350-2 for retrieving long-tail content from the pool. In some embodiments, the content curated in the enriched content pool 230 may be processed by the LT topic/content determiner 340 to recognize long-tail content to facilitate different functions, e.g., determining whether there is enough archive on content in different topics, especially on long-tail topics, and curating content of different topics, including on long-tail topics, to ensure adequate stocking to serve the diverse interests of the users 110.

The LT topic/content determiner 340 is provided for supporting services associated with different long-tail interests. In some embodiments, it determines long-tail topics 370 based on, e.g., uniqueness scores associated with different topics, computed based on enriched user profiles. Overtime, as the uniqueness scores of different topics may change, the LT topic/content determiner 340 may update the list of long-tail topics 370 based on the changing content of the user profiles, determined based on, e.g., tracked user activities reflecting the levels of interests. For example, additional long-tail topics may be added over time. On the other hand, the uniqueness scores of long-tail topics in 370 may change with time when the users' interests in such topics vary. In some embodiments, the ranks of long-tail topics based on uniqueness may change accordingly, reflecting a change in the level of significance of such long-tail topics. Based on long-tail topics 370, the LT topic/content determiner 340 may also determine which articles in the enriched content pool 230 may correspond to long-tail content. In some embodiments, the determination with respect to an article may be based on, e.g., a long-tail content score computed by aggregating the uniqueness scores of topics involved in the article.

The long-tail topics 370 may be used to facilitate a construct of a user profile where long-tail interests may be separately represented. FIG. 3B illustrates an exemplary representation of a user's interests in an enriched user profile indicative of both popular and long-tail interests, in accordance with an embodiment of the present teaching. As shown in FIG. 3B, user 1 is associated with two lists of interests, one corresponding to popular interest (the left column) and the other corresponding to long-tail interests (the column with boldfaced text). The topics in the boldfaced column are those that user 1 showed interests and that are included in the long-tail topics 370. For example, user 1 is recognized to be interested in long-tail interests “parenting,” “real estate,” “sea animals,” “skincare,” . . . , and “space;” while user N is recognized to be interested in long-tail topics “astrology,” “aliens,” “science fiction,” “car repair,” . . . , and “dating.”

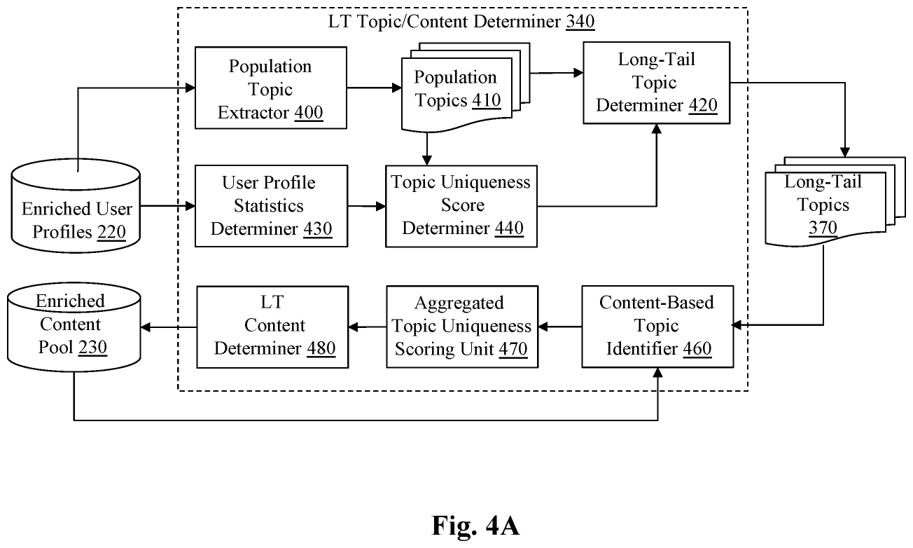

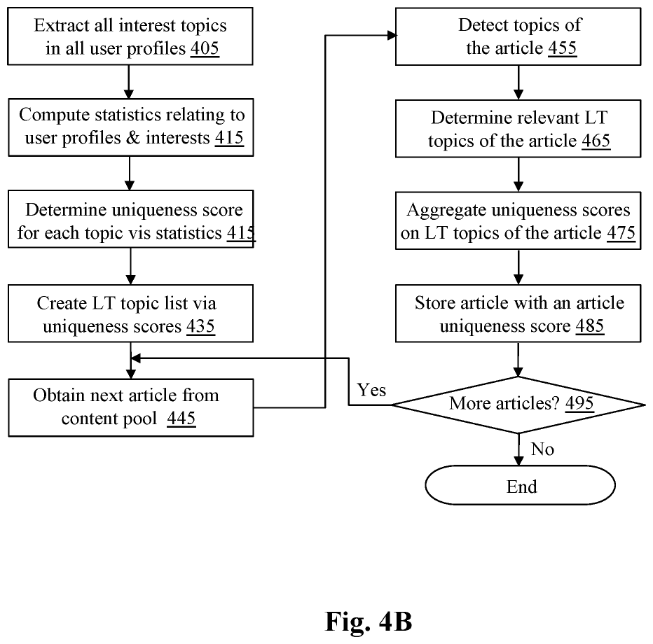

FIG. 3C is a flowchart of an exemplary process of the enriched content engine 210, in accordance with an embodiment of the present teaching. Based on user profiles stored in 220 at a particular time instance, the LT topic/content determiner 340 establishes or updates, at 305, the long-tail topics in 370. As discussed herein, the long-tail topics may be identified based on the uniqueness scores associated with each topic. In some embodiments, the uniqueness is defined in a relative term and different metrics may be used to measure the uniqueness. For instance, the uniqueness score of a topic A may be computed as a ratio of the total number of profiles for all users over the total number of profiles that contain topic A. In this case, a long-tail topic scores higher than that for popular topics. Alternatively, the uniqueness score for a topic may also be defined as a reverse ratio, i.e., the total number of profiles that contain topic A over the total number of profiles for all users. In this case, a long-tail topic scores lower than that for popular topics. As the uniqueness score for each topic is defined based on available user profiles and content thereof, it changes when the total number of user profiles or the number of profiles containing a particular topic change. Once the long-tail topics 370 are established or updated, the LT topic/content determiner 340 determines, with respect to each article in the enriched content pool 230, whether the article is a long-tail content based on topics covered by the article as well as the uniqueness scores for these topics. Details about how to determine the long-tail content are provided below with reference to FIGS. 4A-4B.

With the long-tail topics 370 as well as long-tail content so determined, the enriched content engine 210 proceeds to provide content related services to users. The flowchart illustrated in FIG. 3C is for recommending content to a user. To recommend content of interests to the user, the identity of the user may first be determined at 325 so that the content search/recommendation engine 360 may retrieve the user's enriched profile to determine the popular and long-tail topics that the user is interested in, based on which, the popular interest content retriever 350-1 is invoked to obtain, at 335, content in popular topics and the long-tail interest content retriever 350-2 is invoked to obtain, at 345, long-tail content in long-tail topics. With such retrieved content according to the user's enriched profile, the content search/recommend engine 360 recommends, at 355, the content to the user.

As discussed herein, user activities directed to content in different topics may be tracked in order to continually update the user's profile and accordingly, the long-tail topics as well as long-tail content. To achieve that, the popular interest tracker 310 and the long-tail interest tracker 320 may be invoked to track, at 365, interactions of the user with recommended content. For instance, the user's activities directed to different articles may be recorded and analyzed to measure the engagement. Based on the engagement monitored, the user profile may be accordingly updated at 375. As the long-tail topics are determined based on user profiles, changes to user profiles may trigger accordingly an update to the long-tail topics 370. The process proceeds to step 305 to update the long-tail topics based on updated user profiles and subsequently the detection of long-tail content at 315 based on updated long-tail topics 370, as discussed herein.

FIG. 4A depicts an exemplary high level system diagram of the LT topic/content determiner 340, in accordance with an embodiment of the present teaching. As discussed herein, the LT topic/content determiner 340 is provided for identifying long-tail topics based on existing user profiles and then labeling long-tail content based on the identified long-tail topics. In this illustrated embodiment, the LT topic/content determiner 340 includes two parts, with the first part for determining long-tail topics 370 based on uniqueness scores for topics uncovered from user profiles and the second part for identifying long-tail content by determining, with respect to each content item in the enriched content pool 230, a content item uniqueness score based on long-tail topics.

The first part comprises a population topic extractor 400, a user profile statistics determiner 430, a topic uniqueness score determiner 440, and a long-tail topic determiner 420. The population topic extractor 400 is provided for obtaining topics included in all user profiles as interested by all users (population) so that such topics may be assessed as to whether they are long-tail topics or not. The user profile statistics determiner 430 is provided for compute, e.g., the total number of user profiles and the total numbers of user profiles that include each of the extracted topics, respectively, which are to be used by the topic uniqueness score determiner 440 to compute, with respect each of the topics extracted from user profiles, a uniqueness score based on the statistics related to the user profiles. As discussed herein, in some embodiments, a uniqueness score for a topic may be computed as a ratio of the total number of user profiles over the number of user profiles that specifies that the user is interested in the topic. In this case, the higher the value of the uniqueness score, the more likely that the topic is a long-tail topic. A reverse score may also be used but in that case, a lower uniqueness score represents a higher likelihood that the topic is a long-tail topic.

Based on such computed uniqueness scores for all topics, the long-tail topic determiner 420 generates the long-tail topics 370, which, in some embodiments, may correspond to a list of topics ranked based on uniqueness scores in an order from the most likely long-tail topic to the least likely long-tail topic. In this case, all topics are included in the long-tail topics 370 each with its respective uniqueness score representing the likelihood of being a long-tail topic. In some embodiments, depending on the capacity of the enriched content engine 210, some limitation(s) may be applied to limit the number of long-tail topics included in 370. Such limitations may be based on the number of topics (e.g., 10,000) or based on a threshold of the value of a uniqueness score. Such limitations may be adjusted based on different considerations, such as the capacity of the system, seasonal reasons, etc.

In this illustrated embodiment as shown in FIG. 4A, the second part of the LT topic/content determiner 340 is provided for identifying long-tail content. The identification is with respect to each content item in the content pool, where a content item may be a textual article or a video with visual and textual information. The second part comprises a content-based topic identifier 460, an aggregated topic uniqueness scoring unit 470, and an LT content determiner 480. The content-based topic identifier 460 is provided for identifying the topic(s) associated with each content item retrieved from the content pool 230 (e.g., an article may involve three topics such as science fiction, astrology, and history). In some embodiments, the most relevant long-tail topics may be identified by, e.g., selecting top K topics based on their uniqueness scores. Such identified LT topics for each content item may then be used by the aggregated topic uniqueness scoring unit 470 for determine a content item uniqueness score by, e.g., aggregating the uniqueness scores associated with each of the identified topics. For instance, the content item uniqueness score may be computed by adding all topic uniqueness scores together. In some embodiments, each of the content items in the content pool may be processed this way so that each content item may be associated with a content item uniqueness score. Based on such derived content item uniqueness scores, the LT content determiner 480 may store the content item with its uniqueness scores in the content pool so that through the content item uniqueness scores, long-tail content items may be identified.

FIG. 4B is a flowchart of an exemplary process of the LT topic/content determiner 340, in accordance with an embodiment of the present teaching. Topics included in all user profiles are extracted first at 405. To compute uniqueness scores for such topics, statistics associated with different topics are computed, at 415, based on user profiles. Such statistics computed with respect to each of the extracted topics are then used to determine, at 425, a uniqueness score for the topic. The long-tail topics 370 are then created, at 435, as, e.g., an ordered list of topics with their respective uniqueness scores, e.g., from the most unique, meaning most likely a long-tail topic, to the least unique, meaning least likely a long-tail topic. To identify long-tail content, each content item may be retrieved from the content pool at 445 and used by the content-based topic identifier 460 to detect, at 455, topics associated with the article. Relevant long-tail topics may then be selected from the detected topics of the content item at 465. To determine the uniqueness score for the content item, topic uniqueness scores associated with the relevant long-tail topics may then be aggregated, at 475, to generate the content item uniqueness score. The content item is then stored back to the content pool 230 with its corresponding content item uniqueness score. This process of computing a content item uniqueness score may continue for each and every content items in the content pool 230 until all content items are stored with their respective content item uniqueness scores.

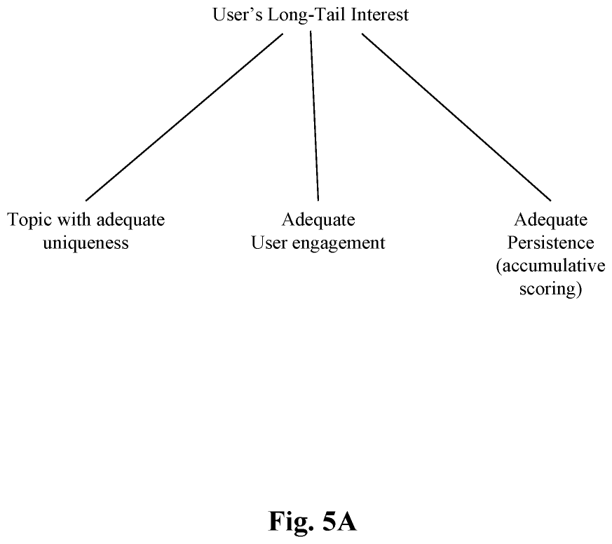

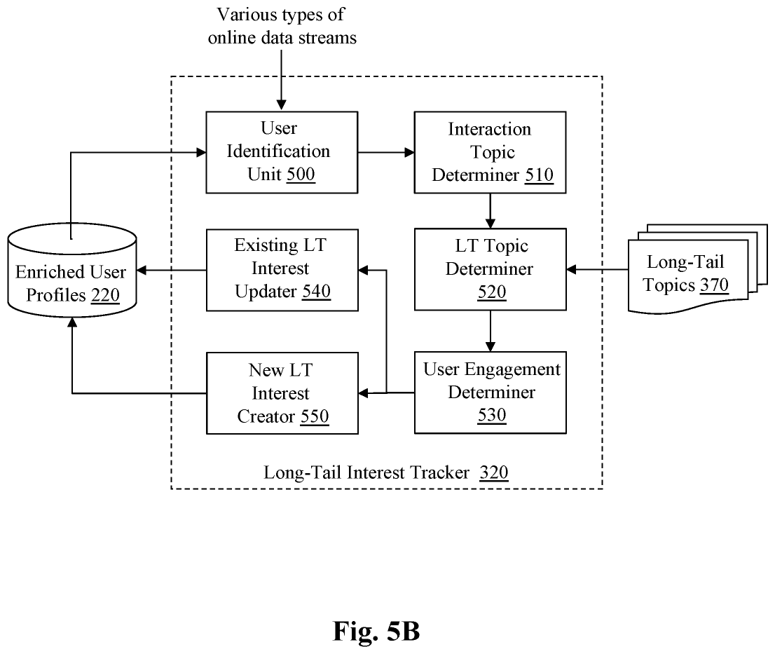

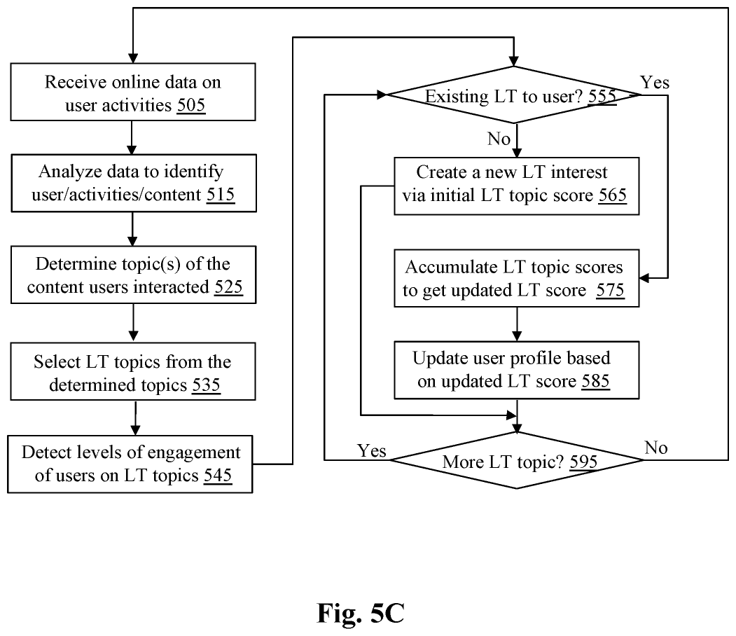

As discussed herein, in addition to deriving the long-tail topics 370 and the enriched content pool 230 with content items specified with content uniqueness scores representing the likelihood of the content being a long-tail content, user activities with respect to long-tail content with long-tail topics may also be tracked continually so that the user profiles may be updated dynamically, which may then be used to adapt the long-tail topics 370 and long-tail content uniqueness scores in the content pool 230. To track users' long-tail interests, there may be different aspects of user activities to be monitored. FIG. 5A shows exemplary considerations in determining user's long-tail interest, in accordance with an embodiment of the present teaching. As shown, a user's long-tail interest may be monitored in terms of whether the user is interested in topics that are adequately unique. In addition, the user may exhibit adequate engagement with long-tail content in such topics. Furthermore, the user's engagement with long-tail content in such topics should persist in time.

FIG. 5B depicts an exemplary high-level system diagram of the long-tail interest tracker 320 for tracking a user's long-tail interests, in accordance with an embodiment of the present teaching. In this illustrated embodiment, the long-tail interest tracker 320 comprises a user identification unit 500, an interaction topic determiner 510, an LT topic determiner 520, a user engagement determiner 530, an existing LT interest updater 540, and a new LT interest creator 550. The user identification unit 500 is provided for receiving online data streams on collected user activities with respect to different content and identifying user identities with respect to different pieces of collected interaction information. The interaction topic determiner 510 is provided for identifying, with respect to each user, the (user, topic) interactions, i.e., all pairings on topics of the content items that the user has interacted with. The LT topic determiner 520 may be provided to recognize long-tail topics that users interacted with, i.e., identifying each (user, long-tail topic) pairing. Such identified information (user identities and long-tail topics that users interacted) may then be used to determine specific user engagement with each of the long-tail topics in order to update respective user profiles.

Accordingly, the user engagement determiner 530 is provided for determining, based on the received activity data, the level of engagement of each user with respect to each of the identified long-tail topics. There may be different ways to determine a level of engagement. For instance, a length of time that a user spent on an article may be an indication of a level of engagement. The speed of scrolling the screen on which an article is displayed may be another cue. Dwelling a longer time at a particular location of an article where content on a specific topic (e.g., new medicine to cure a disease) is presented may signal a stronger level of engagement on a specific topic (e.g., medicine) than on other topics discussed in the article (e.g., topic on health in general). The computation of the engagement level may employ any means, currently available in the art or developed in the future, to obtain an estimated level of engagement.

Based on the estimated level of engagement of each user with respect to each LT topic, the profiles of users may be updated. There may be two situations. In one situation, if a long-tail topic that a user interacted with already exists in the user profile, i.e., it is a known long-tail interest of the user, then the existing information in the user profile on the long-tail interest can be updated. The existing LT interest updater 540 is provided for updating a user's existing long-tail interest based on the user's recent activities directed to the long-tail interest. As discussed herein, each of the long-tail interest topics recorded in a user's profile may be associated with a long-tail topic score. In some embodiments, updating a user's existing long-tail interest may be performed by, e.g., accumulating the long-tail topic scores over time. In some embodiments, the level of engagement may be used as a weight applied to the long-tail topic score and the weighted long-tail topic score may be added to the existing score to obtain an updated score. In this way, a user's long-tail interest score may be accumulated in time, also representing the persistence of the user's interest in a long-tail topic.

In another situation, if a long-tail topic that a user interacted with is not included in the current user profile, i.e., it is a new long-tail interest of the user, then a new long-tail interest needs to be added to the user profile. The next new LT interest creator 550 is provided for adding a new long-tail interest in the user's profile based on the long-tail interest newly discovered from the user's recent activities directed to content item(s) of the long-tail interest. The new entry added to the user's profile for the newly discovered long-tail interest may be added with a long-tail topic score for the long-tail topic or with a weighted long-tail topic score where the weight used may be determined based on the level of engagement estimated. With such a mechanism, the initial long-tail topic score may not be as strong, but if the user's long-tail interest persists, the accumulated long-tail topic score over time may grow over time if it is indeed the interest of the user.

FIG. 5C is a flowchart of an exemplary process of the long-tail interest tracker 320, in accordance with an embodiment of the present teaching. In operation, the user identification unit 500 first receives, at 505, online data stream representing collected information on user activities and analyzes the received data to identify, at 515, identities of users as well as corresponding content items that the users interacted with. From such corresponding content items associated with users, the interaction topic determiner 510 determines, at 525, topics associated with the user interactions. The LT topic determiner 520 selects, at 535, long-tail topics from the determined topics, which may include popular topics. With respect to each of the selected LT topics, the user engagement determiner 530 detects, at 545, a level of engagement of each user with respect to the selected LT topics. Such different types of information may then be used for updating the profiles of the users engaged in the online activities.

For each of the users engaged in online activities, it is checked, at 555 with respect to each of the LT topics that the user acted on, whether the LT topic is already listed as the user's interested topic in the user's profile. If the LT topic is already listed as an interested topic in the user profile, the LT topic score associated with the LT topic in the profile may be changed according to the recent online activities. As discussed herein, in some embodiments, to effectuate a change in user's profile to reflect the user's online activities, the long-tail topic score associated with each LT topic may be updated according to, e.g., an accumulative score for the LT topic. In this case, the existing LT interest updater 540 may be invoked to accumulate, at 575, or combine, e.g., the original LT topic score in the user profile as well as a current LT topic score determined based on, e.g., the type of activity of the user (e.g., positive feedback or negative feedback) and the level of engagement. The accumulated score for the LT topic is then used by the existing LT interest updater 540 to update, at 585, the LT topic score in the user profile.

If the current user profile does not include the LT topic as an interested topic, a new interest entry may be inserted into the user profile as an update. This may be performed by the new LT interest creator 550 at 565. When creating a new LT interest for the user, an appropriate LT topic score may be initially assigned a value. In some embodiments, the long-tail score associated with this LT topic may be used as the initial score value. In some embodiments, a weighted score may be computed as the initial score, computed by using the engagement as the weight. Such a weighted initial score may be subsequently updated if the user continues to consume content in the LT topic with engagement so that the accumulative score may steadily increase so that the long-tail interest of the user in this LT topic is observed over time with persistent interest. The update process as shown in FIG. 5C from step 555 to step 595 continues until all users' profiles have been updated with respect to all LT topics that the users engaged with. When the update process is completed with respect to the received online data stream, determined at 595, the process returns to 505 to receive additional online activity data.

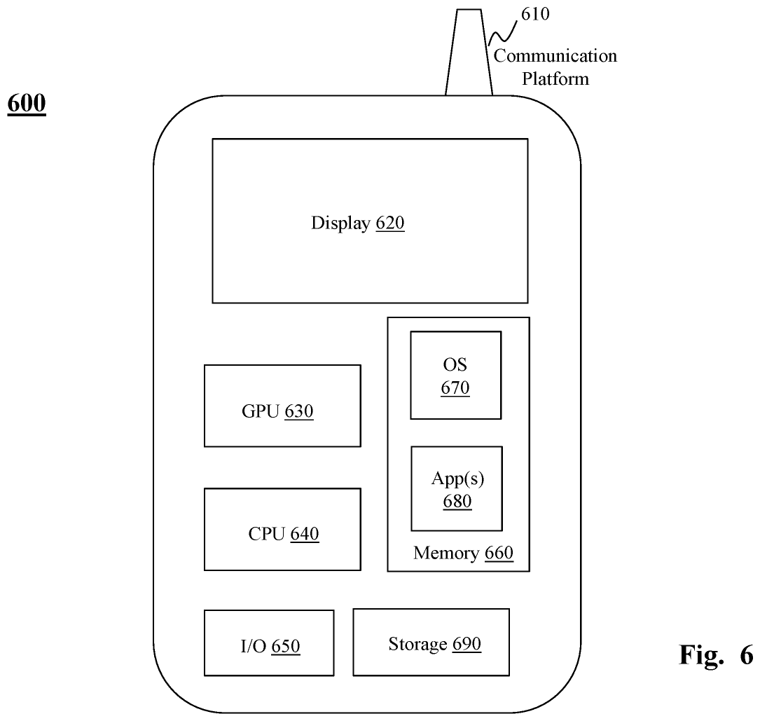

FIG. 6 is an illustrative diagram of an exemplary mobile device architecture that may be used to realize a specialized system implementing the present teaching in accordance with various embodiments. In this example, the user device on which the present teaching may be implemented corresponds to a mobile device 600, including, but not limited to, a smart phone, a tablet, a music player, a handled gaming console, a global positioning system (GPS) receiver, and a wearable computing device, or in any other form factor. Mobile device 600 may include one or more central processing units (“CPUs”) 640, one or more graphic processing units (“GPUs”) 630, a display 620, a memory 660, a communication platform 610, such as a wireless communication module, storage 690, and one or more input/output (I/O) devices 650. Any other suitable component, including but not limited to a system bus or a controller (not shown), may also be included in the mobile device 700. As shown in FIG. 6, a mobile operating system 670 (e.g., iOS, Android, Windows Phone, etc.), and one or more applications 680 may be loaded into memory 660 from storage 690 in order to be executed by the CPU 640. The applications 680 may include a user interface or any other suitable mobile apps for information analytics and management according to the present teaching on, at least partially, the mobile device 600. User interactions, if any, may be achieved via the I/O devices 650 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

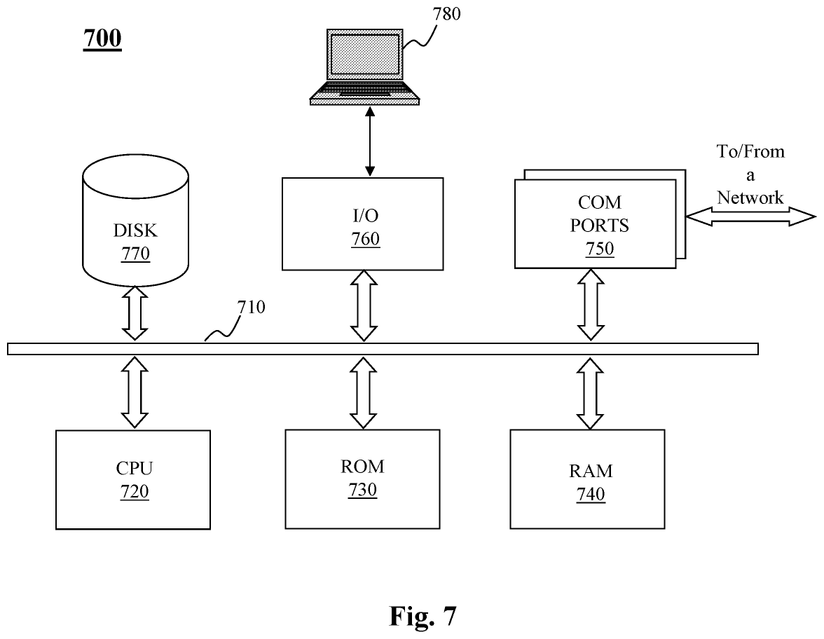

FIG. 7 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information analytical and management method and system as disclosed herein may be implemented on a computer such as computer 700, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 700, for example, includes COM ports 750 connected to and from a network connected thereto to facilitate data communications. Computer 700 also includes a central processing unit (CPU) 720, in the form of one or more processors, for executing program instructions. The exemplary computer platform includes an internal communication bus 710, program storage and data storage of different forms (e.g., disk 770, read only memory (ROM) 730, or random-access memory (RAM) 740), for various data files to be processed and/or communicated by computer 700, as well as possibly program instructions to be executed by CPU 720. Computer 700 also includes an I/O component 760, supporting input/output flows between the computer and other components therein such as user interface elements 780. Computer 700 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.
The following listing of claims replaces all prior listings:

1. A method, comprising:
identifying, from multiple topics that are associated with users in a population and comprise a plurality of long-tail topics and one or more popular topics, each of the plurality of long-tail topics based on a topic uniqueness score for each of the multiple topics, wherein the topic uniqueness score is a ratio of a total number of profiles for the users in the population and a number of profiles of users in the population who are interested in the topic or a reverse of the ratio;
obtaining a user's profile with characterization of the user's long-tail interest with respect to one or more of a plurality of long-tail topics and at least one of the one or more popular topics, wherein each of the one or more long-tail topics in the user's profile is associated with a long-tail topic score representing a degree of the user's interest in the long-tail topic;
identifying, for the user, long-tail content in at least one of the one or more long-tail topics and popular content in the at least one of the one or more popular topics;
sending the long-tail content and the popular content to the user;
invoking a computing device to track online activities of the user directed to the long-tail content;
updating, based on the online activities of the user, at least one long-tail topic score in the user profile associated with the at least one of the one or more long-tail topics.

2. The method of claim 1, wherein the identifying further comprises:
extracting, from the profiles of the users in a-the population, the multiple topics that the users in the population are interested;
with respect to each of the multiple topics,
computing, based on the profiles of the users, a metric relating to a number of the users in the population who are interested in the topic, and
determining the topic uniqueness score for the topic based on the metric; and
generating the plurality of long-tail topics based on some of the topics with their respective uniqueness scores.

3. (canceled)

4. The method of claim 2, wherein the long-tail content is associated with a content uniqueness score obtained by:
detecting one or more topics associated with the long-tail content, wherein at least one of the one or more topics is a long-tail topic;
accessing the topic uniqueness score of each of the at least one long-tail topic;
aggregating the topic uniqueness score of the at least one long-tail topic to generate the content uniqueness score for the long-tail content.

5. The method of claim 1, wherein the step of updating the at least one long-tail topic score associated with the at least one of the one or more long-tail topics comprises:
analyzing the online activities of the user directed to the long-tail content;
identifying each long-tail topic that the user interacted with via the long-tail content;
with respect to each long-tail topic the user interacted with:
determining a level of engagement of the user based on the online activities,
computing a current long-tail topic score for the long-tail topic based on the level of engagement, and
updating the user's profile based on the current long-tail topic score.

6. The method of claim 5, wherein the step of updating the user's profile comprises:
if the long-tail topic already exists in the user's profile,
retrieving a stored long-tail topic score for the long-tail topic in the user's profile,
generating an updated long-tail topic score for the long-tail topic based on the stored long-tail topic score and the current long-tail topic score computed based on the user's activities,
storing the updated long-tail topic score for the long-tail topic in the user's profile to represent the updated user's interest in the long-tail topic.

7. The method of claim 5, wherein the step of updating the user's profile comprises:
if the long-tail topic does not exist in the user's profile,
creating a new long-tail interest in the user's profile corresponding to the long-tail topic,
determining a new long-tail topic score for the long-tail topic based on the current long-tail topic score, and
storing the new long-tail topic score for the long-tail topic in the user's profile to represent the user's new interest in the long-tail topic.

8. Machine readable and non-transitory medium having information recorded thereon, wherein the information, when read by the machine, causes the machine to perform the following steps:
identifying, from multiple topics that are associated with users in a population and comprise a plurality of long-tail topics and one or more popular topics, each of the plurality of long-tail topics based on a topic uniqueness score for each of the multiple topics, wherein the topic uniqueness score is a ratio of a total number of profiles for the users in the population and a number of profiles of users in the population who are interested in the topic or a reverse of the ratio;
obtaining a user's profile with characterization of the user's long-tail interest with respect to one or more of a plurality of long-tail topics and at least one of the one or more popular topics, wherein each of the one or more long-tail topics in the user's profile is associated with a long-tail topic score representing a degree of the user's interest in the long-tail topic;
identifying, for the user, long-tail content in at least one of the one or more long-tail topics and popular content in the at least one of the one or more popular topics;
sending the long-tail content and the popular content to the user;
invoking a computing device to track online activities of the user directed to the long-tail content;
updating, based on the online activities of the user, at least one long-tail topic score in the user profile associated with the at least one of the one or more long-tail topics.

9. The medium of claim 8, wherein the step of identifying further comprises:
extracting, from the profiles of the users in a the population, the multiple topics that the users in the population are interested;
with respect to each of the multiple topics,
computing, based on the profiles of the users, a metric relating to a number of the users in the population who are interested in the topic, and
determining the topic uniqueness score for the topic based on the metric; and
generating the plurality of long-tail topics based on some of the topics with their respective uniqueness scores.

10. (canceled)

11. The medium of claim 9, wherein the long-tail content is associated with a content uniqueness score obtained by:
detecting one or more topics associated with the long-tail content, wherein at least one of the one or more topics is a long-tail topic;
accessing the topic uniqueness score of each of the at least one long-tail topic;
aggregating the topic uniqueness score of the at least one long-tail topic to generate the content uniqueness score for the long-tail content.

12. The medium of claim 8, wherein the step of updating the at least one long-tail topic score associated with the at least one of the one or more long-tail topics comprises:
analyzing the online activities of the user directed to the long-tail content;
identifying each long-tail topic that the user interacted with via the long-tail content;
with respect to each long-tail topic the user interacted with:
determining a level of engagement of the user based on the online activities,
computing a current long-tail topic score for the long-tail topic based on the level of engagement, and
updating the user's profile based on the current long-tail topic score.

13. The medium of claim 12, wherein the step of updating the user's profile comprises:
if the long-tail topic already exists in the user's profile,
retrieving a stored long-tail topic score for the long-tail topic in the user's profile,
generating an updated long-tail topic score for the long-tail topic based on the stored long-tail topic score and the current long-tail topic score computed based on the user's activities,
storing the updated long-tail topic score for the long-tail topic in the user's profile to represent the updated user's interest in the long-tail topic.

14. The medium of claim 12, wherein the step of updating the user's profile comprises:
if the long-tail topic does not exist in the user's profile,
creating a new long-tail interest in the user's profile corresponding to the long-tail topic,
determining a new long-tail topic score for the long-tail topic based on the current long-tail topic score, and
storing the new long-tail topic score for the long-tail topic in the user's profile to represent the user's new interest in the long-tail topic.

15. A system, comprising:
a long-tail topic/content determiner implemented by a processor and configured for identifying, from multiple topics that are associated with users in a population and comprise a plurality of long-tail topics and one or more popular topics, each of the plurality of long-tail topics based on a topic uniqueness score for each of the multiple topics, wherein the topic uniqueness score is a ratio of a total number of profiles for the users in the population and a number of profiles of users in the population who are interested in the topic or a reverse of the ratio;
a content search/recommendation engine implemented by a processor and configured for obtaining a user's profile with characterization of the user's long-tail interest with respect to one or more of a plurality of long-tail topics and at least one of the one or more popular topics, wherein each of the one or more long-tail topics in the user's profile is associated with a long-tail topic score representing a degree of the user's interest in the long-tail topic;
a long-tail interest content retriever implemented by a processor and configured for identifying, for the user, long-tail content in at least one of the one or more long-tail topics and popular content in the at least one of the one or more popular topics;
a user interface implemented by a processor and configured for sending the long-tail content and the popular content to the user; and
a long-tail interest tracker implemented by a processor and configured for
being invoked to track online activities of the user directed to the long-tail content, and
updating, based on the online activities of the user, at least one long-tail topic score in the user profile associated with the at least one of the one or more long-tail topics.

16. The system of claim 15, wherein the long-tail topic/content determiner further configured for:
extracting, from the profiles of the users in the population, the multiple topics that the users in the population are interested;
with respect to each of the multiple topics,
computing, based on the profiles of the users, a metric relating to a number of the users in the population who are interested in the topic, and
determining the a topic uniqueness score for the topic based on the metric; and
generating the plurality of long-tail topics based on some of the topics with their respective uniqueness scores.

17. The system of claim 16, wherein
the topic uniqueness score for each of the topics is derived based on a total number of profiles for the users in the population and the number of profiles of users in the population who are interested in the topic; and
the long-tail content is associated with a content uniqueness score obtained by:
detecting one or more topics associated with the long-tail content, wherein at least one of the one or more topics is a long-tail topic,
accessing the topic uniqueness score of each of the at least one long-tail topic, and
aggregating the topic uniqueness score of the at least one long-tail topic to generate the content uniqueness score for the long-tail content.

18. The system of claim 15, wherein the step of updating the at least one long-tail topic score associated with the at least one of the one or more long-tail topics comprises:
analyzing the online activities of the user directed to the long-tail content;
identifying each long-tail topic that the user interacted with via the long-tail content;
with respect to each long-tail topic the user interacted with:
determining a level of engagement of the user based on the online activities,
computing a current long-tail topic score for the long-tail topic based on the level of engagement, and
updating the user's profile based on the current long-tail topic score.

19. The system of claim 18, wherein the step of updating the user's profile comprises:
if the long-tail topic already exists in the user's profile,
retrieving a stored long-tail topic score for the long-tail topic in the user's profile,
generating an updated long-tail topic score for the long-tail topic based on the stored long-tail topic score and the current long-tail topic score computed based on the user's activities,
storing the updated long-tail topic score for the long-tail topic in the user's profile to represent the updated user's interest in the long-tail topic.

20. The system of claim 18, wherein the step of updating the user's profile comprises:
if the long-tail topic does not exist in the user's profile,
creating a new long-tail interest in the user's profile corresponding to the long-tail topic,
determining a new long-tail topic score for the long-tail topic based on the current long-tail topic score, and
storing the new long-tail topic score for the long-tail topic in the user's profile to represent the user's new interest in the long-tail topic.
